(19) United States
(12) Patent Application Publication
(10) Pub. No.: US 2026/0217023 A1
(43) Pub. Date: Jul. 30, 2026

(54) LIQUID EJECTION HEAD

(71) Applicant: CANON KABUSHIKI KAISHA, Tokyo (JP)

(72) Inventor: MASATAKA NAGAI, Kanagawa (JP)

(21) Appl. No.: 19/451,951

(22) Filed: Jan. 16, 2026

(30) Foreign Application Priority Data
Jan. 28, 2025 (JP) 2025-012101

(51) Int. Cl. B41J 2/14

(52) U.S. Cl. CPC B41J 2/1404; B41J 2/14145; B41J 2/1433; B41J 2002/14419; B41J 2202/03

(57) ABSTRACT

The liquid discharge head includes a flow-path forming member that is stacked between a substrate and a nozzle plate and includes a flow path wall. The flow path wall includes a linear portion extending in a first direction; a first connection portion that is provided on one side of the linear portion in the first direction and is configured to be connected to the substrate; and a second connection portion that is provided on the other side of the linear portion in the first direction and is configured to be connected to a nozzle plate. At least one of the first connection portion and the second connection portion includes a contact surface enlarging portion that protrudes further toward an inner side of a liquid flow path than the linear portion in a second direction and has a larger thickness than the linear portion in the second direction.

### BACKGROUND

### Field of the Technology

The present disclosure relates to a liquid ejection head.

### Description of the Related the Art

As a typical configuration of a liquid ejection head used in a liquid ejection device such as an ink jet printer (recording device), there is known a configuration in which energy, such as heat, is applied from energy generating elements to liquid in a flow path and the liquid is ejected out of an ejection port. The energy generating elements are arranged in the pressure chamber. Two kinds of through holes are formed so as to penetrate the substrate of a chip used for the liquid ejection head, thereby forming liquid flow paths for supplying liquid to the pressure chamber. One of the two kinds of through holes is an inlet port (inflow port) for passing the liquid to be introduced (supplied) into the pressure chamber, and the other is a collection port (outflow port) for passing the liquid to be recovered from the pressure chamber. The two kinds of through holes are arranged for each of the arranged energy generating elements, and a pair of the inlet port and the collection port constitute an independent supply path for each of the energy generating elements. The plurality of arranged through holes communicate with each other via a common flow path on the side opposite to the pressure chamber. Liquid is supplied from the common flow path to each pressure chamber through individual independent supply paths, so that liquid supply to the position facing the energy generating element is further stabilized and the ejection direction of liquid from the ejection port is also stabilized. This achieves recording with high-precision and high-speed liquid ejection.

Also known is a liquid ejection head having a configuration that circulates liquid as means for suppressing an increase in liquid viscosity or the like. The liquid is passed from the inlet port into the pressure chamber and is discharged from one of collection ports, which is located at a position facing the inlet port across the energy generating element. The liquid discharged from the collection port without being ejected from the ejection port is returned to the common flow path and is supplied again to the pressure chamber through the inlet port, so as to circulate. The liquid circulation is generally configured to prescribe the direction of circulation, and basically, the direction of circulation is a one-way direction. The circulation system and a power source used for circulation are not specifically limited. Typical circulation systems include the circulation of a differential pressure type and circulation using a power source such as a pump.

Since such liquid ejection and circulation operations are repeated several tens of millions of times until the end of the service life of the head, the liquid ejection head is required to have sufficient durability to withstand such repeated operations and to continue stable operations. In order to perform high-quality printing at high speed, a sufficient refilling property is necessary in an operation for replenishing (refilling) again the pressure chamber with the liquid that has been ejected .

For this reason, Japanese Patent Application Laid-open No. 2024-93775 discusses a configuration in which a dummy recording element or the like is provided at the row end portion in addition to the main nozzle for performing printing. Since the dummy nozzle is provided in advance, a problem is prone to arise particularly at the row end portion, e.g., the influence of heat accumulation, can be limited to the dummy nozzle region. This can suppress the deterioration of print quality due to the influence of heat or the like in the main nozzle that ejects liquid.

However, the method discussed in Japanese Patent Application Laid-open No. 2024-93775 still has the following concerns. The liquid ejection head forms nozzle rows in which several hundreds to several thousands of ejection ports are arranged in lines. The provision of the dummy nozzles at the row end portions contributes to maintaining the quality of the nozzles at the end portions of the nozzle rows, but does not provide any particular functions for many other nozzles. For example, an opening for supplying liquid to a liquid flow path is present on the cover plate. On the periphery of the cover plate opening, a large amount of liquid flows from the cover plate opening. Hence, peeling may occur due to an increase in stress applied between the nozzle plate and the flow path wall and between the substrate and the flow path wall. In view of such a concern, in the conventional art, the influence at the row end portion is suppressed. However, a concern about stable operations at portions other than the row end portion remains.

### SUMMARY

The present disclosure is directed to provide a technique capable of improving the operation stability of a liquid ejection head.

An aspect of the present disclosure provides a liquid ejection head that includes a substrate including an energy generating element; a nozzle plate including an ejection port configured to open at a position facing the energy generating element; a flow-path forming member stacked between the substrate and the nozzle plate, the flow-path forming member including a flow path wall demarcating a liquid flow path including a pressure chambers containing the energy generating element and the ejection port. The flow path wall includes a linear portion extending in a first direction perpendicular to the substrate; a first connection portion provided on one side of the linear portion in the first direction and configured to connect to the substrate; and a second connection portion provided on an other side of the linear portion in the first direction and configured to connect to the nozzle plate. At least one of the first connection portion and the second connection portion includes a contact surface enlarging portion that protrudes toward an inner side of the liquid flow path in a second direction intersecting the first direction further than the linear portion, and is thicker than the linear portion in the second direction.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B show a conventional liquid ejection head.

FIGS. 2A to 2D show a first embodiment of the present disclosure.

FIGS. 3A to 3D show a second embodiment of the present disclosure.

FIGS. 4A to 4D show a third embodiment of the present disclosure.

FIGS. 5A to 5C are plan views showing various examples of configurations of the planar arrangement of the contact surface enlarging portion.

FIGS. 6A to 6E illustrate the effect of the embodiments according to the present disclosure.

FIGS. 7A to 7E illustrate the requirements of the dimensions and shape of the contact surface enlarging portion.

### DESCRIPTION OF THE EMBODIMENTS

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Furthermore, each embodiment described below includes a plurality of features. However, all of these features are not necessarily essential and they may be arbitrarily combined. Moreover, in the attached drawings, configurations that are the same or similar between the embodiments are denoted by the same reference numerals, and duplicate descriptions is incorporated by reference, for conciseness.

A liquid ejection head according to the present embodiment is used for an ink jet printer acting as a recording apparatus. Ink jet printers of various forms are generally provided with a carriage movable in the scanning direction, and a recording head for ejecting liquid onto a recording medium is mounted on the carriage. The liquid ejection head according to the present example can be used as a recording head. The recording apparatus is an apparatus that forms (records) characters, symbols, and images or the like, for example, by selectively ejecting liquids of multiple colors from the recording head onto a recording medium. Any recording medium may be used if liquid droplets can be ejected onto the recording medium to form an image. For example, media of various materials and forms such as paper, cloth, optical disc label surfaces, plastic sheets, overhead projection (OHP) sheets, and envelopes can be used as the recording medium. Liquid to be ejected from a liquid ejection head, to which the present disclosure is applicable, is typically ink. The liquid is not limited to ink and may also be a reaction fluid or a pretreatment fluid to be added to a liquid ejection device.

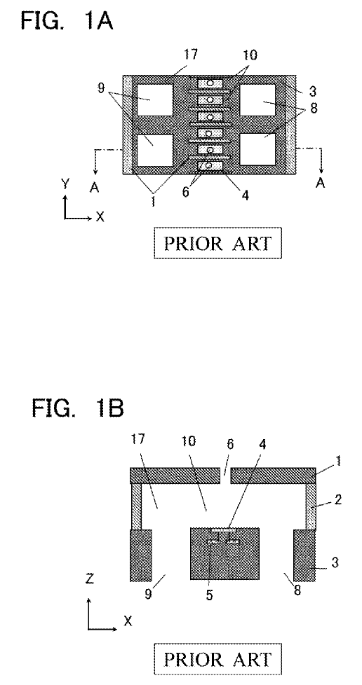

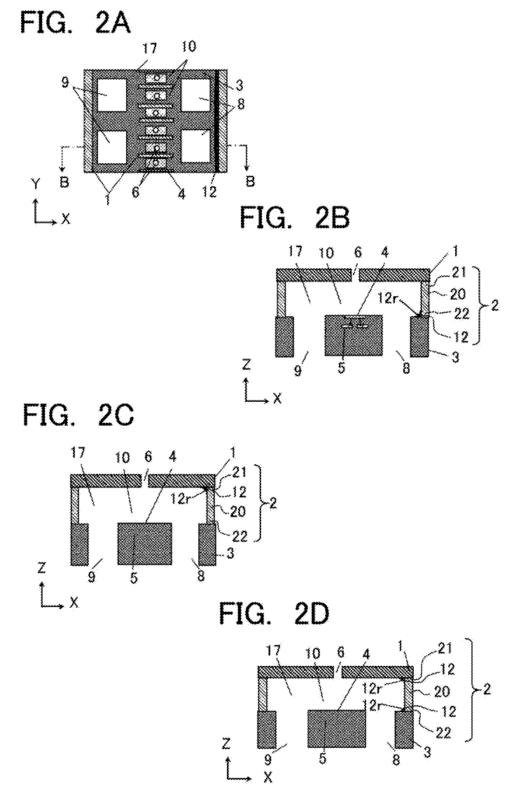

FIGS. 1A and 1B show the configuration of a conventional liquid ejection head. FIG. 1A is a plan view that focuses on the vicinity of the surface of a substrate 3. FIG. 1B is a cross-sectional view taken along line A-A of FIG. 1A, depicting a part of the liquid ejection head. It should be noted that in the description of the conventional liquid ejection head, components common to those of liquid ejection heads according to embodiments of the present disclosure, which will be described later, will be denoted by the same reference numerals for convenience of explanation. In addition, in the liquid ejection heads according to the embodiments illustrated in FIG. 2A and subsequent drawings, the same reference numerals are assigned to the common components.

The substrate 3 has energy generating elements 4, and a liquid flow path 17 and pressure chambers 10 are determined by forming a flow-path forming member 2 and nozzle plates 1 on the substrate 3. The substrate 3 further includes inlet ports 8 and collection ports 9, and liquid circulates in the pressure chamber 10. On the nozzle plate 1, ejection ports 6 are opened at positions facing the energy generating elements 4 provided on the substrate 3. The flow-path forming member 2 stacked between the substrate 3 and the nozzle plate 1 constitutes a flow path wall for demarcating a liquid flow path including the pressure chamber 10 in which the energy generating element 4 and the ejection port 6 are disposed.

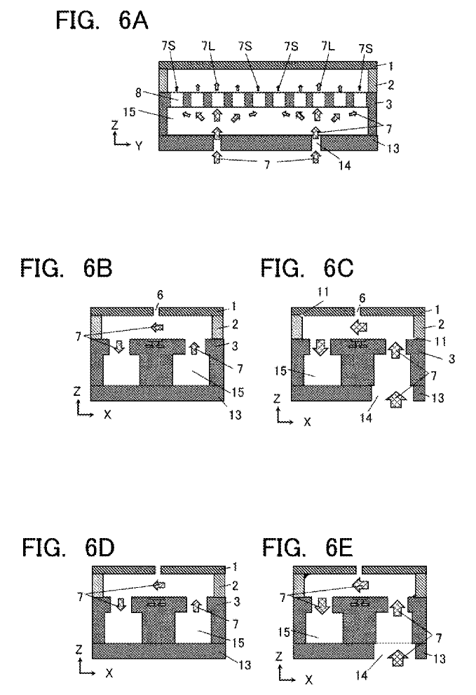

Liquid is fed (supplied) from an ink tank and is added into the pressure chambers 10 from a cover plate opening 14 through a common flow path 15 (see FIG. 6A), and the inlet ports 8. When printing (recording operation or ejecting operation) is performed, the liquid added into the pressure chamber 10 is ejected to the recording medium through the ejection port 6 by energy applied from the energy generating element 4. By repeated scanning and ejection of a carriage, a desired printing pattern is printed. The scanning direction of the carriage corresponds to the Y direction in the drawings. Also, in the case of the configuration capable of liquid circulation, the configuration further includes the collection ports 9. When liquid is circulated in a liquid flow path 17 in order to suppress an increase in liquid viscosity without ejecting the liquid, the liquid is returned to the common flow path 15 through the collection ports 9.

FIGS. 2A to 2D show a liquid ejection head according to a first embodiment of the present disclosure. FIG. 2A is a plan view that focuses on the vicinity of the surface of a substrate 3. FIGS. 2B to 2D are cross-sectional views taken along line B-B of FIG. 2A, depicting a part of the liquid ejection head. FIG. 2B shows an example of a configuration in which a contact surface enlarging portion 12 (first contact surface enlarging portion) having a recessed round portion is provided at a portion (first connection portion) connecting to the substrate 3 on the flow path wall of a flow-path forming member 2 near an inlet port 8 located upstream of a pressure chamber 10 in a liquid flow path. FIG. 2C shows an example of a configuration in which the contact surface enlarging portion 12 (second contact surface enlarging portion) having a recessed round portion is provided at a portion (second connection portion) connecting to a nozzle plate 1 on the flow path wall of the flow-path forming member 2 near the inlet port 8 located upstream of the pressure chamber 10. FIG. 2D shows an example of a configuration including both the contact surface enlarging portion 12 shown in FIG. 2B and the contact surface enlarging portion 12 shown in FIG. 2C.

In the present embodiment, the flow path wall of the flow-path forming member 2 includes a second connection portion 22 connected to the substrate 3 on one side in a direction (Z direction, first direction) perpendicular to the substrate 3, and a first connection portion 21 connected to the nozzle plate 1 on the other side. The flow path wall of the flow-path forming member 2 includes a linear portion 20 that extends between the first connection portion 21 and the second connection portion 22 in a direction (Z direction, first direction) perpendicular to the substrate 3. The flow path wall is formed by the first connection portion 21, the second connection portion 22, and the linear portion 20. The first connection portion 21 is one end portion of the linear portion 20 in the Z direction, a direction perpendicular to the substrate 3, and the second connection portion 22 is the other end portion of the linear portion 20 in the first direction. The flow-path forming member 2 of the present embodiment includes a contact surface enlarging portion (connection surface enlarging portion) 12 that enlarges at least a part of the area of connection with the nozzle plate 1 or the area of connection with the substrate 3 on the flow path wall. The contact surface enlarging portion 12 is configured as a part of the flow-path forming member 2 and is made of a resin material like the flow-path forming member 2.

The configuration in FIG. 2B shows the contact surface enlarging portion 12 that partially enlarges the area of connection with the substrate 3. The contact surface enlarging portion 12 of the configuration in FIG. 2B is provided as a part of the second connection portion 22 so as to protrude from the linear portion 20 to the inside of the liquid flow path 17 in a second direction (X direction in the present example) intersecting a first direction (Z direction in the present example) perpendicular to the substrate 3. Thus, the thickness of the second connection portion 22 in the second direction is larger than that of the linear portion 20, and the area of connection with the substrate 3 on the flow path wall of the flow-path forming member 2 is larger than that of a configuration not including the contact surface enlarging portion 12 (for example, the conventional structure shown in FIG. 1B).

The contact surface enlarging portion 12 is formed such that the thickness of the second connection portion 22 gradually increases in the second direction (X direction) as the contact surface enlarging portion 12 is located away from the linear portion 20 in the first direction (Z direction). On a wall surface facing the liquid flow path 17, the contact surface enlarging portion 12 is formed with a recessed round portion 12r that is round-cornered into a concave shape in a cross section (that is, a cross section shown in FIG. 2B) perpendicular to a third direction (Y direction in the present example) intersecting both the first direction and the second direction.

As described herein, the contact surface enlarging portion 12 includes the recessed round portion 12r as a part of the wall surface facing the liquid flow path 17 in a cross section perpendicular to the third direction. That is, the width of the contact surface enlarging portion 12 in the first direction is larger than the curvature radius of the recessed round portion 12r, and the difference between the thickness of the second connection portion 22 including the contact surface enlarging portion 12 in the second direction and the thickness of the linear portion 20 in the second direction is larger than the curvature radius of the recessed round portion 12r. The thickness of a region other than the contact surface enlarging portion 12 in the first connection portion 21 in the second direction (X direction) and the thickness of a region other than the contact surface enlarging portion 12 in the second connection portion 22 in the second direction (X direction) are equal to the thickness of the linear portion 20 in the second direction (X direction).

The inlet port (inflow port) 8 that allows passage of liquid to be supplied to the pressure chamber 10 is formed by a through hole (first through hole) provided in the substrate 3. The collection port (outflow port) 9 that allows passage of liquid to be recovered from the pressure chamber 10 is formed by a through hole (second through hole) provided in the substrate 3. In the example configurations shown in FIGS. 2B, 2C and 2D, the contact surface enlarging portion 12 is located at a position farther from the pressure chamber 10 than the inlet ports 8 in the second direction (X direction). For clarity, the contact surface enlarging portion 12 is shown at a portion different from the portion of the flow-path forming member 2 (flow path wall). In the present embodiment, the contact surface enlarging portion 12 is composed of the same member as the flow-path forming member 2 and is formed when the liquid flow path 17 is formed by patterning.

If the contact surface enlarging portion 12 is configured as a separate member from the flow-path forming member 2 (flow path wall), another concern may arise about, for example, separation of the flow-path forming member 2 and the contact surface enlarging portion 12 due to a difference in thermal expansion coefficient. In the present embodiment, the contact surface enlarging portion 12 composed of the same member as the flow-path forming member 2 can increase the installation area of the flow-path forming member 2 and the nozzle plate 1, and the installation area of the flow-path forming member 2 and the substrate 3, thereby reducing peeling or the like. As described above, the contact surface enlarging portion 12 composed of the same member as the flow-path forming member 2 is positioned to suppress nozzle peeling or the like without changing the flow rate of liquid.

That is, according to the embodiment of the present disclosure, the provision of the contact surface enlarging portion 12 increases the contact area between the nozzle plate and the flow path wall or between the substrate and the flow path wall as compared with the conventional structure, without upsizing of the chip. The contact surface enlarging portion 12 has the function of reinforcement for reducing interfacial peeling or the like in contrast to the conventional structure. The reduction in interfacial peeling or the like improves the durability of the liquid ejection head to repeat the circulation, ejection, and recovery operations of liquid, thereby continuing the stable operation. The increase in contact area by the contact surface enlarging portion 12 minimizes a reduction in liquid flow rate, thereby keeping the minimum deterioration of the refilling property. Since the contact surface enlarging portion 12 is composed of the same member as the flow path wall (flow-path forming member 2), no concern arises about separation of only the corresponding portion unlike in the conventional structure. That is, both the refilling property of liquid and the quality of the nozzle can be obtained.

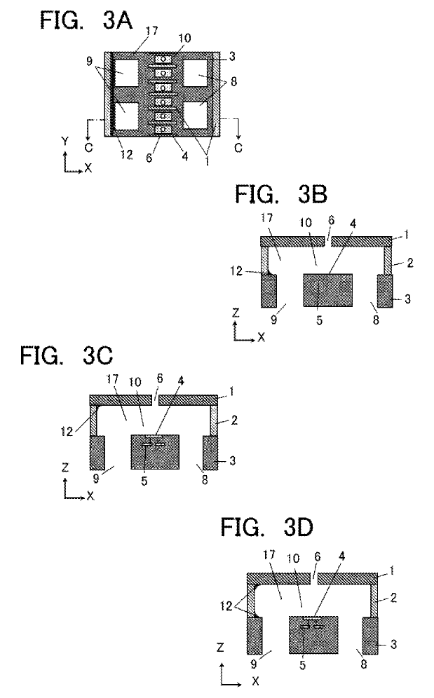

FIGS. 3A to 3D show a second embodiment of the present disclosure. FIG. 3A is a plan view that focuses on the vicinity of the surface of a substrate 3. FIGS. 3B to 3D are cross-sectional views taken along line C-C of FIG. 3A, depicting a part of a liquid ejection head. FIG. 3B shows an example of a configuration in which a contact surface enlarging portion 12 (first contact surface enlarging portion) at a portion (first connection portion) connecting to the substrate 3 on a flow-path forming member 2 near a collection port 9 located downstream of a pressure chamber 10 in a liquid flow path. FIG. 3C shows an example of a configuration in which the contact surface enlarging portion 12 (second contact surface enlarging portion) is provided at a portion (second connection portion) connecting to a nozzle plate 1 on the flow-path forming member 2 near the collection port 9 located downstream of the pressure chamber 10. FIG. 3D shows an example of a configuration including both the contact surface enlarging portion 12 shown in FIG. 3B and the contact surface enlarging portion 12 shown in FIG. 3C.

In the examples shown in FIGS. 3B, 3C and 3D, the contact surface enlarging portion 12 is located at a position farther from the pressure chamber 10 than the collection ports 9 in the second direction (X direction). As described above, the contact surface enlarging portion 12 is formed at a position to suppress nozzle peeling or the like, without changing the flow rate of liquid.

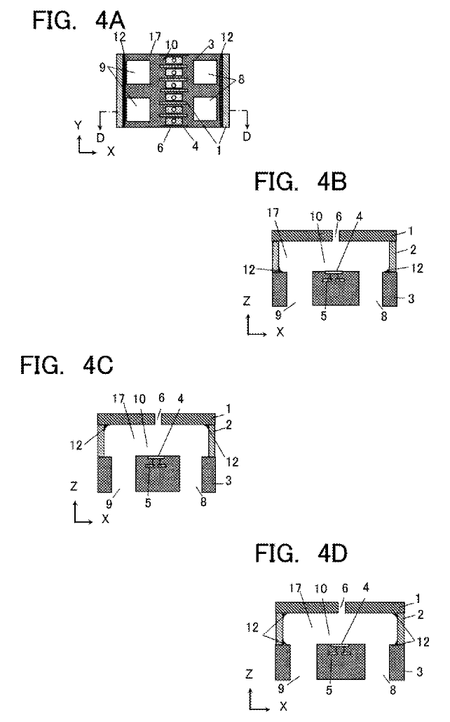

FIGS. 4A to 4D show a third embodiment of the present disclosure. FIG. 4A is a plan view that focuses on the vicinity of the surface of a substrate 3. FIGS. 4B to 4D are cross-sectional views taken along line D-D of FIG. 4A, depicting a part of a liquid ejection head. FIG. 4B shows an example of a configuration in which contact surface enlarging portions 12 (first contact surface enlarging portions) are provided at two portions (first connection portions) connecting to the substrate 3 on a flow-path forming member 2 on the upstream side and the downstream side of a pressure chamber 10. FIG. 4C shows an example of a configuration in which the contact surface enlarging portions 12 (second contact surface enlarging portions) are provided at two portions (second connection portions) connecting to a nozzle plate 1 on the flow-path forming member 2 on the upstream side and the downstream side of the pressure chamber 10. FIG. 4D shows an example of a configuration in which the contact surface enlarging portions 12 are provided at four portions including two portions (first connection portions) connecting to the substrate 3 on the flow-path forming member 2 and two portions (second connection portions) connecting to the nozzle plate 1 on the upstream side and the downstream side of the pressure chamber 10. As described above, the positions and number of contact surface enlarging portions 12 are selected to form the contact surface enlarging portions 12, thereby further suppressing nozzle peeling or the like.

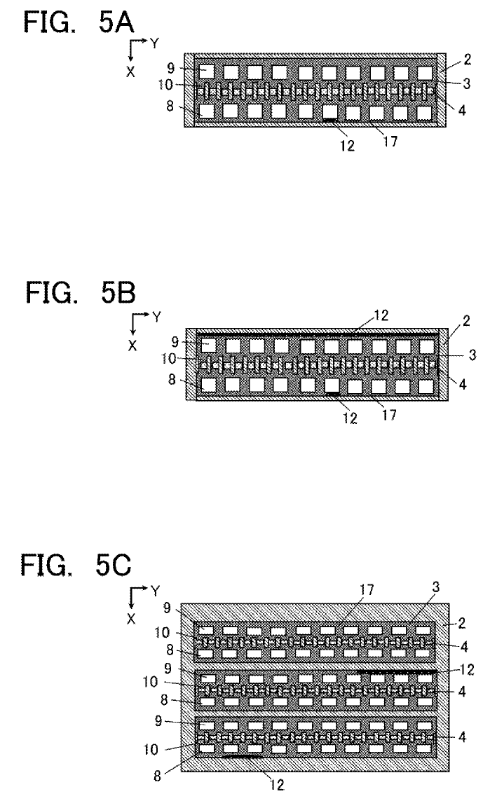

FIGS. 5A to 5C are plan views showing various examples of the planar arrangement of the contact surface enlarging portions 12. As shown in FIGS. 5A to 5C, the energy generating elements 4, the ejection ports 6, the pressure chambers 10, the inlet ports 8, and the collection ports 9 are arranged in a predetermined direction to form one nozzle row. In the present embodiment, the predetermined direction is the Y direction (third direction) intersecting both the Z direction (first direction) and the X direction (second direction). In the nozzle row, the energy generating element 4, the ejection port 6, the pressure chamber 10, the inlet port 8, and the collection port 9 that correspond to one another to form one liquid ejection portion (nozzle portion), and a plurality of such liquid ejection portions are arranged in a predetermined direction. In the examples shown in FIGS. 5A to 5C, the single inlet port 8 and the single collection port 9 are configured as the common inlet port 8 and the common collection port 9 that are used for the two liquid ejection portions adjacent to each other.

FIG. 5A shows an example of a configuration in which the contact surface enlarging portion 12 is formed at one portion corresponding to one of the liquid ejection portions (the energy generating element 4, the ejection port 6, the pressure chamber 10, the inlet port 8, and the collection port 9) constituting one nozzle row. The contact surface enlarging portion 12 is provided near one of the inlet ports 8. In the example shown in FIG. 5A, the contact surface enlarging portion 12 and the inlet port 8 (one of the inlet ports 8) are included in a cross section at a position corresponding to the liquid ejection portion at which the contact surface enlarging portion 12 is disposed, among cross sections of the liquid ejection head taken perpendicularly to the Y direction. The cross section also includes the collection port 9 (one of the collection ports 9). The contact surface enlarging portion 12 is not included in the cross sections at positions corresponding to the other liquid ejection portions.

FIG. 5B shows an example of a configuration in which the contact surface enlarging portions 12 are formed at two portions of one nozzle row. One of the two contact surface enlarging portions 12 is formed near the inlet port 8 and is identical to that of FIG. 5A. One of the two contact surface enlarging portions 12 is formed near the collection port 9 and is formed to extend along each of the pressure chambers 10. That is, the contact surface enlarging portion 12 near the collection ports 9 is longer than the pressure chamber 10 included in the plurality of pressure chambers 10. Therefore, the cross sections of the liquid ejection head taken perpendicularly to the Y direction include a cross section including the pressure chamber 10 and both the contact surface enlarging portion 12 near the inlet port 8 and the contact surface enlarging portion 12 near the collection port 9 and a cross section including the pressure chamber 10 and only the contact surface enlarging portion 12 near the collection port 9. That is, the cross sections including the pressure chambers 10 inevitably include the contact surface enlarging portion 12 near the collection ports 9.

FIG. 5C shows an example of a configuration of the liquid ejection head having three nozzle rows that vary in the presence or absence of the formation, the formation position, and the formation range of the contact surface enlarging portion 12. In the example shown in FIG. 5C, the contact surface enlarging portions 12 are formed longer than the pressure chambers 10 in the Y direction so as to correspond to some adjacent ones of the pressure chambers 10 arranged in the Y direction. That is, in some of the pressure chambers 10 including a first pressure chamber and a second pressure chamber, the cross sections of the liquid ejection head taken perpendicularly to the Y direction include a cross section including the first pressure chamber the contact surface enlarging portion 12 and a cross section including the second pressure chamber and the contact surface enlarging portion 12.

The layout example of the contact surface enlarging portions 12 is not limited to the above example, and for example, the first contact surface enlarging portion 12 included in the first connection portion 21 and the second contact surface enlarging portion 12 included in the second connection portion 22 may be provided at different positions in the third direction.

In this way, in the case of a plurality of nozzle rows in the same chip, the contact surface enlarging portion 12 can be formed in a part of the flow path. In addition, the contact surface enlarging portions 12 may be omitted in some of the nozzle rows. However, providing the contact surface enlarging portions 12 over the entire region of all the rows may deteriorate the refilling property. In the present embodiment, the contact surface enlarging portion 12 can be formed at any position in the nozzle row, thereby suppressing nozzle peeling or the like while maintaining the refilling property.

FIGS. 6A to 6E illustrate the relationship with a distance from the cover plate opening 14. As shown in FIGS. 6A to 6E, the liquid ejection head has a configuration in which a cover plate 13 is stacked on the reverse surface of the substrate 3, to the surface having the stacked flow-path forming member 2. On the surface of the substrate 3 with the cover plate 13 stacked thereon, a recess portion is formed in the Z direction to form the common flow path 15 between the substrate 3 and the cover plate 13. The plurality of inlet ports 8 (first through holes) arranged in the Y direction on the substrate 3 are opened on the common flow path 15, and the plurality of cover plate openings 14 that are provided in the cover plate 13 and are arranged in the Y direction are opened as a plurality of feeding ports that allow passage of liquid to be supplied to the common flow path. That is, the plurality of cover plate openings 14 and the plurality of inlet ports 8 communicate with each other via the single common flow path 15. In the present embodiment, the number of cover plate openings 14 is smaller than the number of inlet ports 8.

FIG. 6A is a cross-sectional view showing the portion of the inlet ports 8 in the nozzle row direction. As indicated by liquid flow directions/flow rates 7, a liquid enters the common flow path 15 through the cover plate openings 14 and then is supplied to the liquid flow path 17 through the inlet ports 8. In this case, for example, it is indicated that a difference in liquid flow rate may occur between a region remote from the cover plate openings 14 and a region near the cover plate openings 14. A flow rate 7S indicates the flow rate of liquid flowing to the inlet port 8 remote from the cover plate opening 14 in the Y direction, and a flow rate 7L indicates the flow rate of liquid flowing to the inlet port 8 near the cover plate opening 14 in the Y direction. In the former case, the flow rate is relatively small, and in the latter case, the flow rate is relatively large. The magnitude of the flow rate is shown in correspondence with the size of the arrow.

FIGS. 6B and 6C show a comparative construction in which the contact surface enlarging portion 12 of the present embodiment is not provided, and show cross-sectional views of any portions of the X-Z plane. The flow rate of liquid at a portion close to the cover plate opening 14 in FIG. 6C is relatively large as compared with that at a portion remote from the cover plate opening 14 in FIG. 6B. In order to supply sufficient droplets to a remote portion as shown in FIG. 6B, the flow rate cannot be reduced even at a close portion. By repeating the circulation and ejection of liquid in this state, a load is continuously applied to the interface around the cover plate openings 14 having a high liquid flow rate, so that a peeling start point 11 is likely to occur.

FIGS. 6D and 6E show cross-sectional views of any portion of an X-Z plane in the present embodiment, in which the contact surface enlarging portions 12 are formed. The state of FIG. 6D showing a portion remote from the cover plate opening 14 is identical to that of FIG. 6B, and there is no particular concern about quality. In contrast, at the position shown in FIG. 6E, that is, at a position corresponding to a cross section including the cover plate opening 14 and the inlet port 8 among the cross sections of the liquid ejection head taken perpendicularly to the Y direction, the contact surface enlarging portions 12 are provided at two portions in the flow path. That is, among the cross sections of the liquid ejection head taken perpendicularly to the Y direction, the cross-section including the contact surface enlarging portions 12 includes both the cover plate opening 14 and the inlet port 8. This can increase the area of contact between the substrate 3 and the flow-path forming member 2 or between the flow path wall and the nozzle plate 1, which does not cause the peeling start point 11. For this reason, compatibility between the refilling property of liquid and the quality of the nozzle can be achieved.

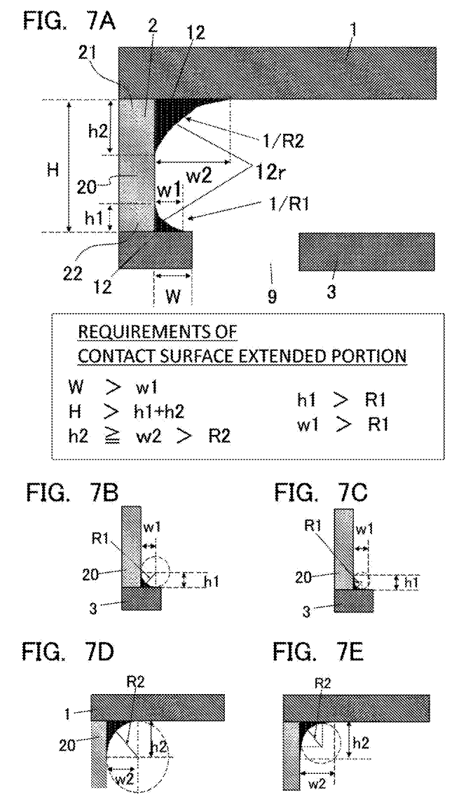

FIGS. 7A to 7E illustrate the requirements of the contact surface enlarging portions 12. FIG. 7A shows an example in which the contact surface enlarging portions 12 are provided at two portions, that is, a corner portion formed by the substrate 3 around the collection port 9 and the flow path wall of the flow-path forming member 2 and a corner portion formed by the flow path wall and the nozzle plate 1. H denotes the height of the liquid flow path 17, W denotes the distance from the flow path wall of the flow-path forming member 2 to the end of the collection port 9, h1 and h2 denote the heights of the contact surface enlarging portions 12, and w1 and w2 denote the widths of the contact surface enlarging portions 12. Moreover, R1 and R2 denote the curvature radii of the surfaces of the recessed round portions 12r included in the contact surface enlarging portions 12, the surfaces facing the liquid flow path 17. That is, the curvatures are 1/R1 and 1/R2.

The contact surface enlarging portion 12 (the contact surface enlarging portion 12 on the lower side of the drawing) formed at a portion (the second connection portion 22) connected to the substrate 3 on the flow path wall of the flow-path forming member 2 is formed so as to cover the corner portion formed by the substrate 3 and the flow path wall (linear portion 20) of the flow-path forming member 2. A width w1 in the X direction satisfies W > w1 where W is a distance between the flow path wall (linear portion 20) and the opening portion of the collection port 9, with w1 satisfying the relationship of W > w1, near the inlet port 8. The relationship between h1 and w1 and R1 satisfies h1 > R1 and w1 > R1.

The contact surface enlarging portion 12 (the contact surface enlarging portion 12 on the upper side of the drawing) formed at a portion (first connection portion 21) connected to the nozzle plate 1 on the flow path wall of the flow-path forming member 2 is formed so as to cover the corner portion formed by the nozzle plate 1 and the flow path wall (linear portion 20) of the flow-path forming member 2. A width w2 in the X direction satisfies h2 > w2, where h2 is a height in the Y direction. In addition, the heights h1 and h2 of the contact surface enlarging portions 12 with respect to the height H of the flow path wall of the flow-path forming member 2 satisfy the relationship of H > h1 + h2. The contact surface enlarging portions 12 do not overlap each other. The relationship between h2 and w2 and R2 satisfies h2 ≥ w2 > R2.

FIGS. 7B and 7C show a configuration difference when the contact surface enlarging portion 12 at the corner portion formed by the substrate 3 and the flow path wall of the flow-path forming member 2 has different curvature radii R1. Unlike in the case of R1 equal to w1 and h1 in FIG. 7B, as shown in FIG. 7C, R1 is smaller than w1 and h1, so that the contact surface enlarging portion 12 has a hemming bottom portion in addition to the rounded portion. This can reduce the influence of downsizing of the liquid flow path 17 while sufficiently securing the installation area of the substrate 3, the flow-path forming member 2, and the contact surface enlarging portion 12. Therefore, the effect of the present disclosure, that is, the compatibility between the refilling property of liquid and the quality of the nozzle can be further enhanced.

FIGS. 7D and 7E show a difference in configuration when the recessed round portion 12r of the contact surface enlarging portion 12 has different curvature radii R2 at the corner portion formed by the flow path wall of the flow-path forming member 2 and the nozzle plate 1. In contrast to R2 equal to w2 and h2 as shown in FIG. 7D, R2 in FIG. 7E is smaller than w2 and h2, so that the contact surface enlarging portion 12 is shaped with a hemming bottom portion in addition to the rounded portion. This can reduce the influence of downsizing of the liquid flow path 17 while sufficiently securing the installation area of the flow-path forming member 2 (flow path wall), the nozzle plate 1, and the contact surface enlarging portion 12. Therefore, the effect of the present disclosure, that is, the compatibility between the refilling property of liquid and the quality of the nozzle can be further enhanced.

Since the contact surface enlarging portion 12 is composed of the same member as the flow-path forming member 2, an increase in the height h does not contribute to the improvement of adhesiveness and may deteriorate the refilling property. Therefore, satisfying the relationships of w1/h1 ≥ 1 and w2/h2 ≥ 1 can improve the adhesiveness without deteriorating the refilling property.

In addition, the recessed round portion 12r of the present embodiment is configured such that the recessed round portion 12r of the contact surface enlarging portion 12 connected to the nozzle plate 1 on the upper side of the drawing has a larger curvature radius than the recessed round portion 12r of the contact surface enlarging portion 12 connected to the substrate 3 on the lower side of the drawing. The recessed round portion 12r of the contact surface enlarging portion 12 connected to the substrate 3 on the lower side of the drawing has a curvature radius of, for example, less than 10 μm, whereas the recessed round portion 12r of the contact surface enlarging portion 12 connected to the nozzle plate 1 on the upper side of the drawing has a curvature radius of, for example, less than 20 μm.

### Examples

A specific example of the first embodiment will be described below. First, the substrate 3 having the energy generating elements 4 or the like on a silicon substrate was prepared, desired resist patterning and etching were repeatedly performed on the substrate 3, the inlet ports 8 and the collection ports 9 were provided thereon, and a structure serving as a part of the common flow path 15 was provided on the reverse surface of the substrate 3 to the surface having the energy generating elements 4. Next, the cover plate 13 having the preformed cover plate openings 14 or the like was prepared and joined to the back side of the substrate 3 to obtain the common flow path 15. A dry film layer of negative-type resist having a film thickness of 20 μm was formed on the front side of the substrate 3, the dry film layer serving as the base material of the flow-path forming member 2 (flow path wall). Thereafter, latent image exposure was performed to obtain the structure of the pressure chamber 10. A dry film layer of negative-type resist having a film thickness of 5 μm was prepared thereon, the dry film layer serving as the base material of the nozzle plate 1. Thereafter, latent image exposure was performed to obtain the structure of the ejection ports 6. Subsequently, a developing solution was dropped onto the substrate 3 including a dry film having been subjected to latent image exposure, and then development based on the exposure pattern was performed. At the time of development, a location that is less soluble and replaceable by a developing solution and is likely to remain was provided, and the developing process was completed in a short time, so that a chip having the contact surface enlarging portion 12 with a surface facing the liquid flow path 17 was obtained at the position corresponding to the cover plate opening 14 of the liquid flow path 17. The surface facing the liquid flow path 17 had a height of 3 μm, a width of 3 μm, and a curvature radius of 2 μm. According to the evaluation of the predetermined ejection performance of the liquid ejection head constituting the chip, it was confirmed that durability for repeatedly circulating liquid and ejecting liquid was provided and there was no functional problem in the refilling property of liquid.

In the embodiments described above, the configurations can be combined with one another.

The present disclosure improves operation stability of the liquid ejection head.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-012101, filed January 28, 2025, which is hereby incorporated by reference herein in its entirety.

What is claimed is:

1. A liquid ejection head comprising:
a substrate including an energy generating element;
a nozzle plate including an ejection port configured to open at a position facing the energy generating element;
a flow-path forming member stacked between the substrate and the nozzle plate, the flow-path forming member including a flow path wall demarcating a liquid flow path including a pressure chambers containing the energy generating element and the ejection port;
wherein the flow path wall includes:
a linear portion extending in a first direction perpendicular to the substrate;
a first connection portion provided on one side of the linear portion in the first direction and configured to connect to the substrate; and
a second connection portion provided on an other side of the linear portion in the first direction and configured to connect to the nozzle plate,
wherein at least one of the first connection portion and the second connection portion includes a contact surface enlarging portion that protrudes toward an inner side of the liquid flow path in a second direction intersecting the first direction, further than the linear portion, and is thicker than the linear portion in the second direction.

2. The liquid ejection head according to claim 1,
wherein a thickness of the contact surface enlarging portion gradually increases in the second direction, with the thickness increasing with increase of distance from the linear portion in the first direction.

3. The liquid ejection head according to claim 2,
wherein the contact surface enlarging portion includes a recessed round portion on a surface of a wall facing the liquid flow path, the recessed round portion having a concave shape in a cross section perpendicular to a third direction intersecting both the first direction and the second direction.

4. The liquid ejection head according to claim 3,
wherein in the cross section perpendicular to the third direction, a width of the contact surface enlarging portion in the first direction is larger than a curvature radius of the recessed round portion.

5. The liquid ejection head according to claim 3,
wherein in the cross section perpendicular to the third direction, a difference between a thickness of the first connection portion or the second connection portion including the contact surface enlarging portion in the second direction and a thickness of the linear portion in the second direction is larger than a curvature radius of the recessed round portion.

6. The liquid ejection head according to claim 3, wherein the contact surface enlarging portion includes a first contact surface enlarging portion included in the first connection portion and a second contact surface enlarging portion included in the second connection portion, and
in the cross section perpendicular to the third direction, a curvature radius of the recessed round portion included in the second contact surface enlarging portion is larger than a curvature radius of the recessed round portion included in the first contact surface enlarging portion in the contact surface enlarging portion.

7. The liquid ejection head according to claim 6,
wherein the curvature radius of the recessed round portion included in the first contact surface enlarging portion is less than 10 μm.

8. The liquid ejection head according to claim 6,
wherein the curvature radius of the recessed round portion included in the second contact surface enlarging portion is less than 20 μm.

9. The liquid ejection head according to claim 1,
wherein the contact surface enlarging portion includes a first contact surface enlarging portion included in the first connection portion and a second contact surface enlarging portion included in the second connection portion, and
the first contact surface enlarging portion and the second contact surface enlarging portion are provided at different positions in a third direction intersecting both the first direction and the second direction.

10. The liquid ejection head according to claim 1,
wherein a thickness of a region other than the contact surface enlarging portion in the first connection portion in the second direction and a thickness of a region other than the contact surface enlarging portion in the second connection portion in the second direction are equal to a thickness of the linear portion in the second direction.

11. The liquid ejection head according to claim 1,
wherein the contact surface enlarging portion is a part of the flow path wall.

12. The liquid ejection head according to claim 1,
wherein the flow-path forming member is made of a resin material.

13. The liquid ejection head according to claim 1,
wherein the substrate includes a first through hole forming an inflow port for passage of liquid to be supplied to the pressure chamber, and a second through hole forming an outflow port for passage of liquid to be recovered from the pressure chamber, and
the contact surface enlarging portion is located at at least one of a position farther from the pressure chamber than the first through hole in the second direction and a position farther from the pressure chamber than the second through hole in the second direction.

14. The liquid ejection head according to claim 13 further comprising:
a cross section perpendicular to a third direction intersecting both the first direction and the second direction, the cross section including the contact surface enlarging portion and the first through hole.

15. The liquid ejection head according to claim 13 further comprising:
a cross section perpendicular to a third direction intersecting both the first direction and the second direction, the cross section including the contact surface enlarging portion and the second through hole.

16. The liquid ejection head according to claim 1,
wherein a plurality of pressure chambers, including the pressure chamber, are arranged in a third direction intersecting both the first direction and the second direction,
wherein the plurality of pressure chambers include a first pressure chamber and a second pressure chamber adjacent to the first pressure chamber in the third direction, and
wherein the contact surface enlarging portion is longer in the third direction than the individual pressure chambers included in the plurality of pressure chambers.

17. The liquid ejection head according to claim 16,
wherein a cross section of the liquid ejection head includes the contact surface enlarging portion and the first pressure chamber and is perpendicular to the third direction, and
wherein another cross section of the liquid ejection head includes the contact surface enlarging portion and the second pressure chamber and is perpendicular to the third direction.

18. The liquid ejection head according to claim 1, further comprising:
a cover plate stacked on a surface of the substrate opposite to a surface having the flow-path forming member stacked thereon,
wherein the substrate includes a plurality of first through holes configured to form inflow ports that allow passage of liquid to be supplied to the pressure chambers, the plurality of first through holes being arranged in a third direction intersecting both the first direction and the second direction, and
wherein a common flow path communicating with each of the plurality of first through holes is formed between the substrate and the cover plate.

19. The liquid ejection head according to claim 18,
wherein the cover plate includes a plurality of feeding ports arranged in the third direction, the plurality of feeding ports configured to allow passage of liquid to be supplied to the common flow path, and
wherein the number of feeding ports is less than the number of first through holes.

20. The liquid ejection head according to claim 18,
wherein a cross section of the liquid ejection head includes the contact surface enlarging portion, the first through hole, and the feeding port, and is perpendicular to the third direction.
